(19) United States
(12) Patent Application Publication
(10) Pub. No.: US 2025/0100009 A1
(43) Pub. Date: Mar. 27, 2025

(54) SYSTEM AND METHOD FOR ROTATIONAL COATING OF NANOCOMPOSITES AND NANOSHEET COATINGS PRODUCED THEREFROM

(71) Applicant: University of Connecticut, Farmington, CT (US)

(72) Inventors: Montgomery T. Shaw, Coventry, CT (US); Luyi Sun, Andover, MA (US); Zaili Hou, Stone Mountain, GA (US); Sonia Elena Chavez, Arlington, MA (US)

(21) Appl. No.: 18/372,042

(22) Filed: Sep. 22, 2023

(51) Int. Cl. B05D 1/00; B05D 3/02; B82Y 30/00

(52) U.S. Cl. CPC B05D 1/005; B05D 3/0263; B82Y 30/00

(57) ABSTRACT

A coated article includes a container that is optionally lined with a substrate and is characterized by an inner surface. A nanosheet coating that includes a binder and nanosheets is disposed on the inner surface. The nanosheet coating displays a higher periodicity between the nanosheets in a direction parallel to the substrate than in a direction perpendicular to the substrate. A rotational coating system for disposing a nanosheet coating on a container includes
a motor, a source for discharging a dispersion and a radiation source. The motor is operative to rotate the container. The container is optionally lined with a substrate and is characterized by an inner surface. The source discharges a dispersion on to the inner surface. The dispersion includes a solvent, a binder and nanosheets. The radiation source is operative to irradiate the dispersion to promote the formation of a nanosheet coating on the inner surface.

### BACKGROUND

### Field of the Invention

The disclosure relates to a rotational coating system for preparing a nanosheet coating, methods of rotational coating of nanocomposites, and nanosheet coatings produced by rotational coating.

### Description of the Related Art

Nanocomposite compositions are produced from mixtures of multiple materials including polymers and nanomaterials. Nanocomposite compositions of a polymer and nanomaterials can provide articles with enhanced mechanical properties in comparison to non-composite articles manufactured from the primary polymer. Accordingly, the production of nanocomposites coatings from a mixture of polymers and two-dimensional nanomaterials (nanosheets) can generate coatings with improved performance. Production of nanosheet coatings generally relies on shear stress to align nanosheets within a coating in order to produce coatings with increased uniformity and barrier properties.

A need remains for improved techniques to prepare nanosheet coatings and improved nanosheet coatings produced therefrom.

### SUMMARY

The above described and other features are exemplified by the following figures and detailed description.

A coated article includes a container that is optionally lined with a substrate and is characterized by an inner surface. A nanosheet coating that includes a binder and nanosheets is disposed on the inner surface. The nanosheet coating displays a higher periodicity between the nanosheets in a direction parallel to the substrate than in a direction perpendicular to the substrate.

A rotational coating system for disposing a nanosheet coating on a container includes
a motor, a source for discharging a dispersion and a radiation source. The motor is operative to rotate the container. The container is optionally lined with a substrate and is characterized by an inner surface. The source discharges a dispersion on to the inner surface. The dispersion includes a solvent, a binder and nanosheets. The radiation source is operative to irradiate the dispersion to promote the formation of a nanosheet coating on the inner surface.

A method for preparing a nanosheet coating on a container includes charging a dispersion comprising a plurality of nanosheets, a binder and a solvent into the container. The container is optionally lined with a substrate and is characterized by an inner surface. The container is rotated to cause spreading of the dispersion on the inner surface. The solvent is removed during rotation to provide a nanosheet coating on the inner surface. The nanosheet coating displays a higher periodicity between the nanosheets in a direction parallel to the substrate than in a direction perpendicular to the substrate.

### BRIEF DESCRIPTION OF THE FIGURES

Referring now to the figures, which are exemplary embodiments, and wherein the like elements are numbered alike.

FIG. 1 is an embodiment of a rotational coating system;

FIG. 2A is a schematic top view of an exemplary single nanosheet;

FIG. 2B is a schematic side view of an exemplary single nanosheet;

FIG. 3 is a base 10 logarithmic scale (log-log) graph illustrating coating thickness [nanometers, (nm)] versus centripetal acceleration [meters per second squared, (m/s²)];

FIG. 4 is a base 10 logarithmic scale (log-log) graph illustrating transmittance at 400 nm (%) versus centripetal acceleration (m/s²);

FIG. 5 is a base 10 logarithmic scale (log-log) graph illustrating turbidity at 400 nm in inverse nanometers (nm⁻¹) versus centripetal acceleration (m/s²);

FIG. 6 is a base 10 logarithmic scale (log-log) graph illustrating interlayer distances (d spacing in angstroms) between MMT nanosheets versus centripetal acceleration (m/s²);

FIG. 7 is a base 10 logarithmic scale (log-log) graph illustrating Full Width at Half Maximum (FWHM) in degrees for MMT nanosheets versus centripetal acceleration (m/s²); and

FIG. 8 is a base 10 logarithmic scale (log-log) graph illustrating oxygen permeability for MMT nanosheets at 10⁻¹⁶ standard cubic centimeter times nanocomposite layer thickness in centimeters per centimeter squared seconds Pascals [10⁻¹⁶ (cm³_{STP}·cm)/(cm²·s·Pa)] versus centripetal acceleration (m/s²).

### DETAILED DESCRIPTION

Disclosed herein is a nanosheet coating (hereinafter coating) produced by a rotational coating method that includes a polymeric binder and nanosheets that are layered and are oriented to be substantially parallel in a first direction to a substrate upon which they are disposed. They are also oriented in a second direction that is perpendicular to the substrate. The periodicity in the first direction is significantly greater than the periodicity in the second direction. In other words, the nanosheet coating displays a higher average periodicity between the nanosheets in a direction parallel to the substrate than in a direction perpendicular to the substrate.

In one embodiment, the nanosheets arrange themselves in a plurality of interleaved layers on the substrate upon which they are disposed. The interleaving produces tortuous pathways between the nanosheets, which renders it difficult for ambient molecules (e.g., undesirable ambient gases) to diffuse across the coating in a direction that is perpendicular to the substrate. The interleaving of the nanosheets produces a coating that displays enhanced surface coverage at a low cost, barrier properties against penetration by undesirable molecules such as oxygen and water, and high transmittance when compared with coatings produced by non-rotational coating methods.

Disclosed herein too is a system for rotational coating of nanocomposites on either an inner surface of a container (with no substrate included on its inner surface) or on a substrate disposed on an inner surface of the container. A method of using the rotational coating system is also disclosed herein. The method includes coating the inner surface of the container or the substrate with a dispersion of nanosheets under an applied rotational force about a rotational axis. In an embodiment, the applied centrifugal and centripetal forces cause the nanosheets to slide past each and to orient themselves to be substantially parallel to the inner surface of the container or the inner surface of the substrate. The rotational coating system can apply constant, uniform, and high force to nanosheets to provide an ordered structure during the rotational coating process. Order within the coating suspension can be obtained within seconds after it is disposed in the container (with or without the substrate disposed therein) and the rotation is begun. The orientation of the rotational axis of the system can be varied throughout the coating process or kept stationary (i.e., it is not moved from one position to another) during rotation. In a preferred embodiment, the orientation of the rotational axis of the system is kept stationary during coating to minimize unwanted vibration. The system is adaptable to continuous coating and to the coating of irregular surfaces. Multiple nanocomposite layers can be applied directly on the inner surface of either the container or the substrate using the system.

Nanosheet coatings produced, using the assemblies and methods disclosed herein, exhibit greater barrier properties than traditional coating methods of dip coating, doctor blade coating, spray coating, spin coating, and the like. Potential applications of the coating technique include coatings upon food packaging, containers that carry ingestible fluids (e.g., medicine carrying containers, soft drinks, canned vegetables and fruits, and the like), dielectric materials, and biomedical devices.

The coating composition (“dispersion”) disclosed herein comprises a binder, a solvent, and nanosheets. In an embodiment, a layered mineral can be exfoliated either prior to or during the coating process to provide the coating in the container. In an embodiment, the binder and the solvent can interact to facilitate the exfoliation. In another embodiment, a temperature change may be used to facilitate the exfoliation. The exfoliation produces nanosheets that are dispersed in the binder and solvent to form a stable suspension (one where the nanosheets do not undergo phase separation from the coating composition).

“Ambient temperature,” as used herein, refers to the air temperature of an environment or surface temperature of an object.

“And/or” includes any and all combinations of one or more of the associated listed items.

“Nanocoating,” as used herein, refers to coatings containing nanomaterials and/or coatings of 1 to 1000 nanometers (nm) thick.

“Nanomaterials,” as used herein, refers to materials with at least one dimension that is less than approximately 100 nm.

“Nanosheets,” as used herein, refers to two-dimensional nanomaterials with a thickness of 1 to 100 nm.

“p-value,” as used herein, is defined as the probability, under the assumption of no effect or no difference (null hypothesis) of obtaining a result equal to or more extreme than what was actually observed.

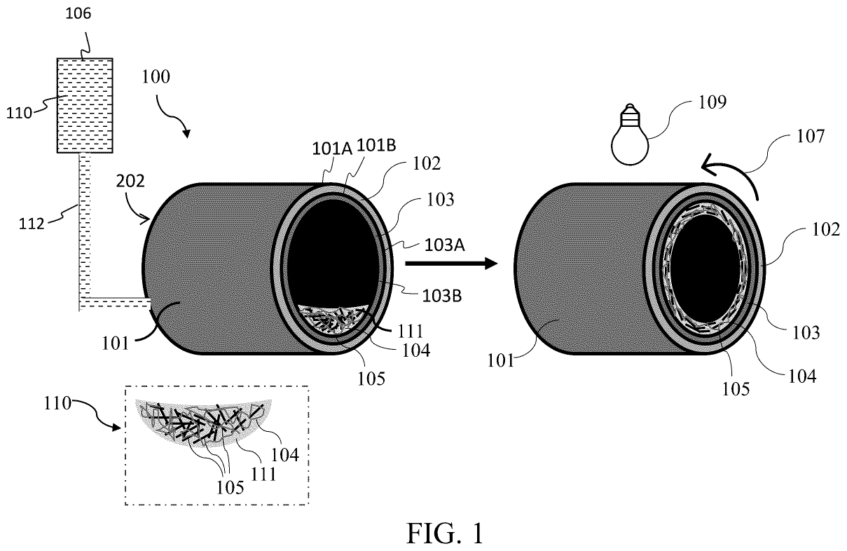

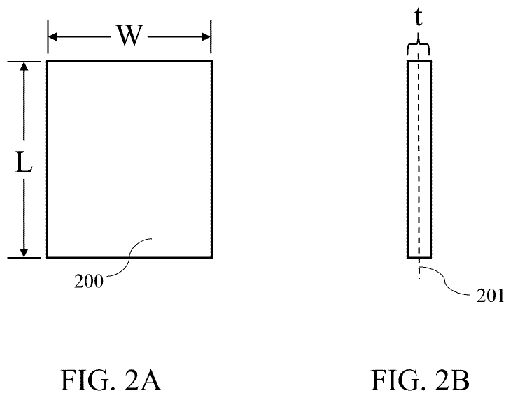

FIG. 1 depicts an exemplary embodiment of a rotational coating system 100 (hereinafter system 100) that may be used to facilitate orientation of nanosheets on the inside of a container. FIGS. 2A and 2B are schematic depictions of a single exemplary nanosheet of length L, width W, thickness t having a major surface 200 and longitudinal axis 201 respectively. FIG. 2A is a top view of the exemplary nanosheet, while FIG. 2B depicts the side view of the nanosheet of the FIG. 2A.

With reference now to FIG. 1, the system 100 can include a container 101 configured to be in an open (as shown) or closed state. In some embodiments, the outer rim 102 of the container 101 can be configured to receive a lid. The container 101 is preferably tubular with one or both opposing ends open. In an embodiment, at least one end of the container may be open, with the opposing end being sealable after the coating process has occurred. In another embodiment, the container may be provided with a substrate 103 (disposed on an inner surface of the container 101) that is coated with the coating.

In some embodiments, the container 101 is in contact with a motor or an apparatus to facilitates rotation during the coating process. In some embodiments, a pad (not shown) is disposed under the motor to absorb vibrational energy. The inner surface of the container may or may not contain the substrate. While the FIG. 1 shows the use of a substrate 103 inside the container 101, it is to be understood that the container may be subjected to the process without the substrate. The process described below uses the substrate 103 but can just as equally be applied to a container without the substrate 103.

During use, the container 101, whose inner surface is in contact with a substrate 103, is charged with a dispersion 110 from a reactor 106 that includes a binder 104 and a plurality of nanosheets 105 in a solvent. The dispersion 110 is fed to the container 101 via a conduit 112. The conduit 112 may be fitted with valves and pumps (not shown) to control the flow of the dispersion 110. The solvent and binder may exfoliate the nanosheets 105 prior to being charged to the container 101 or may exfoliate during the rotation inside the container 101.

The container 101 is then subjected to rotation 107. In an embodiment, rotation can involve rotation about an axis that lies in the center of the container (is concentric with a longitudinal central axis of the container). In another embodiment, rotation can involve rotation about an axis that lies within the container but is eccentric with the longitudinal central axis of the container, i.e., the axis of rotation is separated by a small distance from the central axis of the container. In yet another embodiment, the rotation can involve revolving about a longitudinal axis that lies outside the container but is parallel to a longitudinal central axis of the container. During rotation 107, the dispersion 110 contacts an exposed surface of the substrate 103. Nanosheets 105 from the dispersion 110 are disposed on the substrate 103 along with the binder 104 and solvent 111. The container 101 is then rotated to orient the nanosheets 105 in an orientation parallel to the surface of the substrate 103. Rotation of the container 101 orients the nanosheets 105 due to the preferential orientation of the major surface of the nanosheet 200 perpendicular to the centrifugal force. The major surface is the surface whose area is a product of the length and width and has the largest surface area of any surface of the nanosheet.

As the solvent 111 is removed, the nanosheets 105 are held in position by the binder 104. As noted above, the oriented nanosheets are interleaved and are arranged in a layered fashion on the substrate 103 (or alternatively directly on an inner surface of the container 101). A longitudinal axis 201 of the nanosheets has an average orientation that is parallel to the substrate inner surface. The longitudinal plane passthrough a plane that is parallel to the largest surface of the nanosheet and is parallel to the longest edge of the nanosheet.

In some embodiments, the container 101 is rotated until the final coating is dried, cured, and/or crosslinked to a desired level. In some embodiments, the system can include a heat source, an irradiation source, a vacuum source, or a combination thereof to dry, cure, and/or crosslink the final coating. For example, the coating can be heated with a heat source, such as a lamp 109, during rotation to dry the coating and remove the solvent. In other embodiments, the coating can be crosslinked via UV irradiation, or another suitable crosslinking method during rotation. In other embodiments, evaporation, curing, sublimation, and/or crosslinking can take place alone or in combination with one another. In some embodiments, the coating can undergo simultaneous or sequential evaporation, curing, sublimation and/or crosslinking. The container 101 can be rotated for 5 seconds to 24 hours, 1 minute to 1 hour, or 5 minutes to 30 minutes to provide the final coating.

By varying the concentration of nanosheets and binder in the dispersion and by varying the chemistry of the dispersion, sheets of different thicknesses with different extents of interleaving between the sheets can be obtained.

Within the system 100, the container 101 can be cylindrical in shape. The container 101 can be open on both ends, open on one end, or closed on both ends. In an embodiment, the container 101 comprises a wall 202 having an outer radial surface 101A and an inner radial surface 101B. The wall 202 may be a solid wall or a porous wall. The wall 202 is preferably a solid wall.

During the manufacturing of the coating, the container 101 is typically mounted on jaws (not shown) that are in rotary communication with a motor (not shown) or another apparatus capable of rotating the container 101. The motor may be a rotary motor, a stepper motor, a gear motor, and the like. The container can be rotated at varying speeds of about 0.01 revolutions per minute (rpm) to about 4500 rpm, and about 0.1 rpm to about 3000 rpm. In some embodiments, the radius of the cylindrical cylinder can be about 0.5 centimeters (cm) to about 1 meter, about 1 cm to about 500 cm, or about 5 cm to about 100 cm. As radial acceleration is linearly dependent on the radius of the cylinder, the radial acceleration of the container 101 can be about 0.01 to about 20,000 meters per second squared (m/s²), and about 0.1 to about 2000 m/s².

As shown in FIG. 1, the substrate 103 to be coated is disposed within the cylindrical container 101. While the container is shown to have a circular cross-section, it may have any other geometry such as square, rectangular, triangular, and the like. The substrate 103 can be placed against the interior wall of the cylindrical container 101, on an inner radial surface 101B of the container 101 prior to or during the coating process. In some embodiments, the substrate is placed 103 tightly against some portion of the inner radial surface 101B of the cylindrical container 101. In an embodiment, the outer surface 103A of the substrate 103 contacts an inner surface 101B of the container 101, while the inner surface 103B of the substrate is subjected to the coating process and eventually coated with the nanosheets. The substrate 103 to be coated can be placed in whole or in part within the container 101. In some embodiments, the substrate 103 can be continuously passed through the container 101 during the coating process. For example, the substrate 103 can be a spiraled film structure that is coated within the container 101, one portion of the substrate 103 at a time, and the spiraled coated substrate 103 can be pulled through the container as the coating process continues on another portion of the substrate 103. The container 101 thus serves as a guide to direct the substrate 103 through it during the coating process. The container 101 also serves as a support for the substrate 103 during the coating process. In an embodiment, the substrate 103 is in a tight tolerance fit (e.g., an interference fit) with an inner radial surface 101B of the container 101. The container 101 by virtue of its ability to guide and support the substrate 103 enables the formation of a uniform coating on an inner surface 103B of the substrate 103.

In embodiments, the substrate 103 can be coated in batches. In some embodiments, only a portion of the substrate 103 is coated. The coating on the substrate 103 can be conducted on both the inner surface and the outer surface of the substrate in successive steps.

When only the container 101 (without the substrate 103) is to be coated, the dispersion 110 is disposed on an inner surface of the container either before or subjecting the container to rotation. The coating on the container or on the substrate may be manufactured in a single pass or in multiple passes. In a single pass, the coating is applied with one charge of the requisite amount of dispersion 110 from the reactor 106 followed by rotation of the container. In a multiple pass process, the coating is applied by providing the container with 2 or more charges of the dispersant followed by rotation of the container after each charge.

For the coating process, a dispersion 110 of a binder 104, a plurality of nanosheets 105, and a solvent 111 is charged into the container 101 with the substrate 103 is charged to the container 101 from the source 106. In some embodiments, the substrate 103 can be placed in the container 101 before the dispersion 110, simultaneously with the dispersion 110, or after the dispersion 110. The substrate 103 can be coated with the dispersion on one surface and then re-oriented within the container 101 to expose another surface of the substrate 103 for coating. In an embodiment, if the container 101 has porous walls 202, then the substrate 103 may simultaneously be coated on the inner surface 103B and on the outer surface 103A.

In some embodiments, an initial wetting step is performed where the container 101 is contacted with the substrate 103 following which the dispersion 110 is charged to the container 101. The container 101 is rotated to wet an inner surface 103B of the substrate 103 with the dispersion 110. Macroscopically visible dispersion 110 remaining on the substrate 103 after the initial wetting step can be removed from the container or left in the container to coat another substrate or another portion of the same substrate. The dispersion 110 and the substrate 103 are rotated in the container 101 until the desired coating thickness is obtained or the desired cure or dryness level is obtained.

The container 101 and/or the substrate 103 to be coated can comprise a ceramic, a fabric, a metal, a paper, a polymer, or a combination thereof. It is desirable for the container and/or the substrate to be flexible so that it can be bent during the coating process. In an embodiment, the container and/or the substrate may be a rigid substrate under ambient conditions but is temporarily rendered flexible during the coating process. This temporarily induced flexibility may be due to its interaction with the coating composition or due to processing conditions (e.g., elevated temperature and pressure) used during the coating process. The substrate regains its rigidity upon removal of these temporary conditions. The container and/or the substrate 103 is preferably an organic polymer. It is to be noted that the organic polymers listed below may also be used as binders.

Organic polymers used in the container 101 and/or the substrate 103 may be selected from a wide variety of thermoplastic polymers, blends of thermoplastic polymers, thermosetting polymers, or blends of thermoplastic polymers with thermosetting polymers. The organic polymer may also be a blend of polymers, copolymers, terpolymers, or combinations of the foregoing organic polymers. The organic polymer can also be an oligomer, a homopolymer, a copolymer, a block copolymer, an alternating block copolymer, a random polymer, a random copolymer, a random block copolymer, a graft copolymer, a star block copolymer, a dendrimer, a polyelectrolyte (polymers that have some repeat groups that contain electrolytes), a polyampholyte (a polyelectrolyte having both cationic and anionic repeat groups), an ionomer, an intrinsically conducting polymer, or the like, or a combination of the foregoing organic polymers. The organic polymers have number average molecular weights greater than 10,000 grams per mole (g/mol), greater than 20,000 g/mol, and greater than 50,000 g/mol.

Examples of thermoplastic polymers include a polyacrylic, a polycarbonate, a polyalkyd, a polystyrene, a polyolefin, a polyester, a polyamide, a polyaramid, a polyamideimide, a polyarylate, a polyurethane, an epoxy, a phenolic, a polysiloxane, a polyarylsulfone, a polyethersulfone, a polyphenylene sulfide, a polysulfone, a polyimide, a polyetherimide, a polytetrafluoroethylene, a polyetherketone, a polyether ether ketone, a polyether ketone ketone, a polybenzoxazole, a polyoxadiazole, a polybenzothiazole, a polybenzothiazinophenothiazine, a polypyrazinoquinoxaline, a polypyromellitimide, a polyguinoxaline, a polybenzimidazole, a polyoxindole, a polyoxoisoindoline, a polydioxoisoindoline, a polytriazine, a polypyridazine, a polypiperazine, a polypyridine, a polypiperidine, a polytriazole, a polypyrazole, a polycarborane, a polyoxabicyclononane, a polydibenzofuran, a polyphthalide, a polyacetal, a polyanhydride, a polyvinyl ether, a polyvinyl thioether, a polyvinyl alcohol, a polyvinyl ketone, a polyvinyl halide, a polyvinyl nitrile, a polyvinyl ester, a polysulfonate, a polysulfide, a polythioester, a polysulfone, a polysulfonamide, a polyurea, a polyphosphazene, a polysilazane, a polyolefin, a polyethylene glycol, a polylactic acid (PLA), a poly (lactic-co-glycolic acid) (PLGA), or the like, or a combination thereof.

Examples of polyelectrolytes include polystyrene sulfonic acid, polyacrylic acid, pectin, carrageenan, alginates, carboxymethylcellulose, polyvinylpyrrolidone, or the like, or a combination thereof.

Examples of intrinsically conducting polymers include polyaniline, polyacetylene, polypyrrole, poly (3,4-ethylenedioxythiophene) (PEDOT), or a combination thereof. In an embodiment, the intrinsically conducting polymers may be neutralized with an acid.

Examples of thermosetting polymers include epoxy polymers, unsaturated polyester polymers, polyimide polymers, bismaleimide polymers, bismaleimide triazine polymers, cyanate ester polymers, vinyl polymers, benzoxazine polymers, benzocyclobutene polymers, acrylics, alkyds, phenol-formaldehyde polymers, novolacs, resoles, melamine-formaldehyde polymers, urea-formaldehyde polymers, hydroxymethylfurans, isocyanates, diallyl phthalate, triallyl cyanurate, triallyl isocyanurate, unsaturated polyesterimides, or the like, or a combination thereof. In an exemplary embodiment, the binders are water soluble such as polyvinyl alcohol, polyacrylamides, hydroxymethylcellulose, or a combination thereof.

The container and/or the substrate may include naturally occurring polymers such as hemp, jute, cotton, silk, wool, paper, wood pulp paper, or a combination thereof. Metal and ceramic containers and/or substrates can be ductile in nature. Suitable metals include aluminum, iron, tin, stainless steel, copper, titanium, or alloys thereof. Suitable ceramics include indium titanium oxide, quartz, silica, alumina, zirconia, titania, or a combination thereof.

In an embodiment, when the container is used for carrying ingestible fluids such as soft drinks, sauces, flavorants (e.g., curries, salad dressings, and the like), a suitable polymer is polyester. A suitable ceramic is quartz or silica. A suitable metal is tin (for canned food stuffs such as tomato sauces, preserved fruits and vegetables, and the like) or aluminum (for soft drinks such as ginger ale, coca cola, and the like).

In an embodiment, the container and/or the substrate may be independently opaque or may be optically transparent. The transparent container and/or substrate may be capable of transmitting 50% or more, 60% or more, 70% or more, 80% or more and 90% or more of the visible light incident on the container. In an embodiment, the substrate may be opaque while the container is optically transparent or alternatively, the container is opaque while the substrate is optically transparent. In another embodiment, both the container and the substrate may be optically transparent or both opaque.

The dispersion 110 for coating the substrate 103 is a combination of a binder 104, nanosheets 105, and a solvent 111. The dispersion 110 can be charged into the container 101 before, during, or simultaneously with the substrate 103. The rotation of the container 101 facilitates alignment of the nanosheets 105 in the dispersion 110 with the inner radial surface 101B of the container 101. The dispersion 110 can be a solution, a mixture, or a suspension. In some embodiments, the dispersion 110 is a gel. The dispersion 110 can be a viscosity of about 0.3 millipascal second (mPa·s) to about 10,000 mPa·s. The binder 104 and the nanosheets 105 can be present in the dispersion 110 in equal weight amounts (1:1) or in amounts of about 20:1 to about 1:20. For example, the binder 104 and the nanosheets 105 can each independently be present in the dispersion 110 at a weight percent of 0.05 to 20 wt %, 0.1 to 7.5 wt %, or 0.2 to 3 wt % based on the total weight of the dispersion 110.

In some embodiments, a dispersion of a binder 104 and a dispersion of nanosheets 105 are combined and a crosslinking agent can be added to the final dispersion 110. Suitable crosslinking agents include glyoxal, glutaraldehyde, sodium borate (borax), citric acid, and combinations thereof.

The binder 104 used in the coating composition 101 can be an organic polymer as listed above. In an embodiment, it is desirable for the binder to be capable of exfoliating the mineral that contains the nanosheets. It is also desirable for the binder 104 to be compatible with the nanosheets 105. In an embodiment, the organic polymer may be used in the form of a polymer or alternatively, in the form of a polymer precursor.

The nanosheets 105 are obtained by exfoliating a layered mineral. The layered mineral contains plates that are arranged to be substantially parallel to each other prior to being exfoliated. Examples of layered minerals that can be used to produce the nanosheets 102 include clays such as, for example phyllosilicates [e.g., montmorillonite (MMT)], boron nitride (BN), graphite oxide (GO), graphite, tungsten disulfide (WS₂), molybdenum disulfide (MoS₂), silicates, aluminosilicates, phosphates, phosphonates, layered double hydroxides, metal oxides, metal chalcogenides, metal oxyhalides, metal halides, hydrous metal oxides, or a combination thereof. In an embodiment, the layered mineral is montmorillonite. The nanosheets 105 can be exfoliated (prior to being utilized in the coating) so that they can be dispersed in the dispersion 110. In an embodiment, the exfoliation may be brought about by thermal treatment, intercalation, or a combination thereof. During exfoliation intermolecular forces that hold the nanosheets together are disrupted thus permitting the nanosheets to come apart from each other and to be dispersed in the binder and the solvent. The exfoliation and dispersion of the nanosheets permits the dispersion 110 to be in the form of a stable suspension. This stable suspension is then charged to the container 101 and the coating of the substrate 103 is permitted to commence. The stable suspension prevents the ingredients of the dispersion 110 from phase separating during the coating process.

The nanosheets 105 upon being exfoliated are two-dimensional (they are sheet-like) and have lengths of 10 to 10,000 nanometers (nm) and/or widths of 10 to 10,000 nm. The thickness of the nanosheets 102 can be 1 nm to 100 nm or 5 to 50 nm. FIG. 2A is a schematic top view and FIG. 2B is a schematic side view of an exemplary single nanosheet. The nanosheet has a length (L), width (W) and thickness (t). As may be seen, the length and/or width is significantly greater than the thickness. The nanosheets can have aspect ratios (length or width to thickness ratios) of 0.1 to 10,000. The high aspect ratios facilitate an orientation of the sheets on the substrate as they contact the substrate from the dispersion. In some embodiments, the dispersion of nanosheets is accomplished in a solvent such as water in the absence of additional chemicals and surfactants. In some embodiments, additives can be added to the nanosheets to facilitate intercalation and/or the exfoliation processes.

The nanosheets 105 are present in the dispersion 110 in an amount of 0.05 to 20 wt %, 0.1 to 7.5 wt %, or 0.2 to 3 wt % based on a total weight of the dispersion 110.

The solvent 111 used in the dispersion 110 to solubilize the binder 104 and optionally to compatibilize the binder 104 with the nanosheets 105. In another embodiment, the solvent may facilitate the exfoliation of the nanosheets 105. In some embodiments, the binder 104 and the nanosheets 105 can be dispersed in the same or different solvents and later combined.

It is generally desirable to use solvents that are environmentally friendly and that can be recycled. Examples of these solvents include water, liquid carbon dioxide, liquid nitrogen, ethanol, dimethyl sulfoxide (DMSO), acetone, acetonitrile, methanol, butanol, propanol, tetrahydrofuran, N-methylpyrrolidone (NMP), amine-based organic solvents (e.g., N,N-dimethylpropylamine), water-soluble organic solvents, or a combination thereof. Exemplary solvents include water, ethanol or liquid carbon dioxide.

The solvent 111 is present in the dispersion 110 in an amount of 85.0 to 99.9 wt % or 90 to 98 wt % based on a total weight of the dispersion 110.

It is to be noted that the dispersion 110 may contain other additives such as surfactants (which may be used to facilitate exfoliation), antioxidants, antiozonants, initiators (which may be used to facilitate crosslinking of polymeric precursors, should they be used to manufacture the binder), cross-linkers, anti-viral and/or anti-bacterial additives, anti-fungal additives, thermal stabilizers, dyes, colorants, pigments, or a combination thereof.

The binder 104 (in polymeric or in polymeric precursor form) and/or the solvent 111 facilitate an exfoliation of the mineral to form nanosheets 105. In an embodiment, the exfoliation occurs because the binder 104 intercalates the nanosheets 105 and breaks bonds of the inorganic mineral thereby liberating the nanosheets. The nanosheets 105 are dispersed in the binder 104 and the solvent 111 to form the dispersion 110. The dispersion 110 is therefore a stable suspension with the nanosheets 105 randomly dispersed in a mixture of the binder 104 and the solvent 111. The stable suspension does not undergo phase separation with the passage of time. The binder may include one or more of the organic polymers listed above and will not be detailed again in the interests of brevity.

The binder 103 is present in the coating composition in an amount of 0.05 to 20 wt %, 0.1 to 7.5 wt %, or 0.2 to 3 wt %, based on a total weight of the dispersion 110.

In an embodiment, if a porous container 101 is used, then the dispersion 110 may optionally be sprayed on to the outer radial surface 101A of the container wall 202 prior to or during rotation. The dispersion may be transported through the porous container wall to contact an outer surface 103A of the substrate and coat it (during rotation), while the inner surface 103B is simultaneously being coated on the inside.

After wetting of the surface of the substrate 103 with the dispersion 110, the container 101 can be rotated to obtain the desired finished state in the coating. Finishing can include evaporation, curing, sublimation, and/or crosslinking. In some embodiments, finishing of the coating can occur outside of the container 101. In some embodiments, a radiation source (e.g., lamp 109) can be used during rotation to finish the coating process as shown in FIG. 1. In some embodiments, a lamp 109 can be placed inside the container 101 or outside of the container 101. The irradiation can be applied directly to the nanosheet coating composition (i.e., it is incident on the nanosheet coating composition without first contacting the container and/or the substrate) or can be incident upon the nanosheet coating composition through the container and/or the substrate. Crosslinking of the coating can occur via irradiation with a suitable irradiation source such as a solar (visible light) irradiation, xray radiation, electron beam radiation, and UV irradiation. For example, a UV lamp can be used to crosslink the coating. Crosslinking can take place via chemical processes in the absence of irradiation. Evaporative drying of the coating can take place by irradiating with an infrared lamp within and/or outside of the container 101. In some embodiments, the lamp 109 can surround the outside of the container 101. In some embodiments, evaporative drying can take place under ambient, room temperature conditions of about 20° C. to about 25° C. In further embodiments, evaporative drying can take place under high pressure, low pressure, or a combination thereof. For example, at high pressure, the evaporative drying can take place under a pressure of about 1 atmosphere (atm) to about 35 atm. For evaporative drying at low pressure, the drying can take place under a pressure of about 0.1 pascal to 1 atm, using a vacuum source such as vacuum pump. The pressure can be changed during the drying process.

The nanosheet coating (devoid of the solvent after drying) may include 10 to 70 wt %, preferably 20 to 60 wt %, and more preferably 25 to 55 wt % of the binder and 30 to 90 wt %, 20 to 80 wt % and 45 to 75 wt % of the nanosheets, based on the nanosheet coating after all volatiles are extracted.

The container or the substrate with the coating disposed thereon may be used to store ingestible solids or fluids over long periods of time ranging from one day to several years. In an embodiment, the container with the nanosheet coating disposed on its inner surfaces may be used to store and transport edible and ingestible food items such as soft drinks, fruit juices, preservatives and medicines. In another embodiment, the substrate with the coating disposed thereon (may be removed from the container) and be used to package and transport different articles of commerce. The articles of commerce may include food stuffs or other non-edible items. In an embodiment, the substrate with the coating disposed thereon may be injection molded, compression molded, vacuum formed or thermoformed to form a variety of commercial articles such as trays for storing frozen ready to eat foods, water bottles for storing and transporting water, fruit juices, concentrates and medicines. In yet another embodiment, the nanosheet coating may be separated from the substrate and may be used independently to package articles of commerce such as foods (e.g., meats, frozen vegetables, and the like), toys, textiles, medicines (e.g., saline solutions) and the like. The nanosheet coating may be easily printed upon because of the presence of the nanosheets.

The ability of the container with the coating disposed thereon, the substrate with the coating disposed thereon or the independent coating (without the container or substrate as backing) to be used for food packaging or medicine packaging stems from is superior barrier properties. The coating serves as an excellent barrier against oxygen and water vapor transmission through it.

A nanosheet coating produced by the rotational coating method can have an oxygen permeability of less than 0.01×10⁻¹⁶ (cm³_{(STP)}cm)/(cm²·s·Pa), less than 0.03×10⁻¹⁶ (cm³_{(STP)}cm)/(cm²·s·Pa), less than 0.005×10⁻¹⁶ (cm³_{(STP)}cm)/(cm²·s·Pa), or less than 0.002×10⁻¹⁶ (cm³_{(STP)}cm)/(cm²·s·Pa). The water vapor transmission rate of the coating can be less than about 6 grams per 100 inches squared per day (g/100 in²/day). The coating can have a thickness of about 100 nm to about 900 nm, about 200 nm to about 800 nm. In some embodiments, the coating can have a thickness of about 300 nm. The nanosheet coating can have a transmittance of greater than 60% at about 380 nm to about 700 nm.

The following non-limiting examples exemplify the coating apparatus, the coating composition and the method of coating detailed above.

### EXAMPLES

### Materials

The materials used include the following: polyvinyl alcohol (PVA) [Mowiol 8-88, molecular weight: 67,000, degree of hydrolysis: 86.7% to 88.7%, Kuraray]; sodium montmorillonite (MMT) (PGN nano clay, Mineral Technologies Inc.); glutaraldehyde (GA as a 50 wt % aqueous solution; Sigma-Aldrich), hydrochloric acid (HCl) (37 wt %; Fisher Scientific), and Polyethylene terephthalate (PET) film (thickness: 25.4 micrometers) was obtained from Toray Plastics (America) Inc.

The rotational coating system used included an open cylinder (inner diameter: 11.4 cm, height: 14.8 cm, thickness: 0.95 mm) for the container 101, made of stainless steel. The stainless steel container was horizontally attached to a motor (Bodine Electric Company, NSH-12RG). A soft polyurethane pad was placed under the motor to minimize vibration during the rotation of the cylindrical container.

### Testing Equipment and Conditions

Rotation speeds in rpm were measured by a contact tachometer (Protmex, MS6208A).

The thickness of the coating was measured with a Semiconsoft MProbe Thin Film Measurement System. Thickness measurements were conducted on at least two independently produced specimens for each coated sample. The average values are reported along with 95% confidence intervals.

The Ultraviolet-Visible (UV-Vis) spectra of the coated samples were characterized using a UV-Vis spectrophotometer (Lambda 900, PerkinElmer). To obtain the UV-Vis spectra of the PVA/MMT nanocoating layer alone, the spectrum of an uncoated PET film substrate was subtracted from the spectrum of the coated sample. The turbidity “τ” of the nanocoating layer was calculated using the Beer-Lambert law [In (I/I₀)=τδ)] to compare the optical qualities of the coating layers, where light path length “δ” is the coating thickness, I and I₀ are the ingoing and outgoing beam intensities, respectively.

The X-ray diffraction (XRD) patterns of the coated samples were recorded on a Bruker D2 diffractometer using copper K-alpha (Cu Kα) radiation. The full widths at half maximum (FWHM) of XRD pattern peaks were determined by fitting the intensity data with a Gaussian probability density function.

The oxygen transmission rates (OTRs) of the coated samples were characterized using a MOCON OX-TRAN 1/50 OTR tester at 23° C. and 0% relative humidity (RH) in accordance with ASTM D3985. The oxygen permeability of the nanocoating layers was calculated using a resistance model and normalized by thickness using the following equation (1):

$$Pp = ( \frac{Φ p}{Pp} + \frac{Φ g}{Pg} ) \hat{} ( - 1 ) , Φ p = \frac{dp}{dp + dg} , Φ g = \frac{dg}{dp + dg} \qquad ( 1 )$$

where “dp,” “Φp,” and “Pp” are the thickness, volume fraction, and permeability of the polymer substrate, respectively, and “dg,” “Φg,” and “Pg” are the corresponding values of the nanocoating layer.

The viscosity of the coating dispersion was measured on an AR-G2 rheometer (TA Instruments, New Castle, Delaware) using a Couette geometry with a 25.4 millimeter (mm) cylinder and a 1 mm gap. The temperature was set at 25° C. during the measurements.

TABLE 1
Physical properties of PVA/MMT suspensions of different concentrations.
Measurements were taken at a temperature of 25° C.

| Final Solids | | |
|---|---|---|
| Concentration | Suspension Viscosity | Suspension density (kilograms |
| (wt %) | (Pascal-second, Pa-s) | per cubic meter, kg/m³)* |
| 0.5 | 0.0012 | 1002.2 |
| 1.0 | 0.0015 | 1004.4 |
| 1.5 | 0.0021 | 1006.7 |

*Estimated using volume additivity

### Statistical Methods

A multilinear regression model was employed to determine the significance of each processing parameter (suspension concentration and centripetal acceleration) on each final film property (thickness, transmittance, turbidity, d spacing, FWHM, and oxygen permeability). This model is expressed as equation (2):

$$y = A + Bc + Ca + {Dc}^{2} + Eca + {Fa}^{2} \qquad ( 2 )$$

where “y” is the logarithm (base 10) of the of the unitless number representing the final film property; “A,” “B,” “C,” “D,” “E,” and “F” are unknown parameters; and “c” and “a” are the logarithm (base 10) of the unitless number representing centripetal acceleration and suspension concentration, respectively. The statistical significance of each parameter was evaluated by assessing the associated p-values.

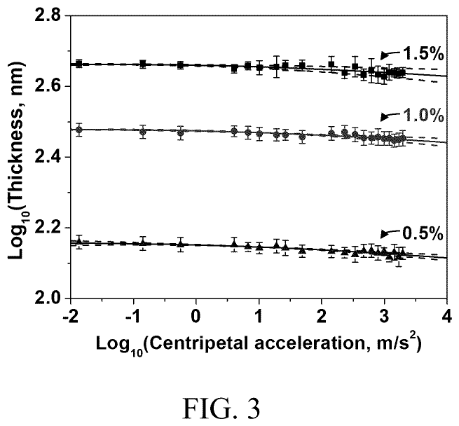

In FIGS. 3 to 7, the final solids concentrations of the PVA/MMT suspensions are labeled as weight percents: 0.5%, 1.0%, and 1.5%; where the mass of the PVA and MMT are equivalent (i.e., 0.25 weight percent (wt %) PVA and 0.25 wt % MMT for the 0.5 wt % sample, and so forth). The solid and dashed lines represent a multilinear regression statistical model and 95% confidence interval bands for each concentration, respectively.

### Example 1—Preparation of PVA/MMT Dispersions

A 10.0 wt % PVA solution was prepared by adding PVA pellets to deionized (DI) water and maintaining the temperature at 80° C. for 2 hours while stirring vigorously. A 1.5 wt % sodium MMT dispersion was prepared by adding dry sodium MMT to DI water while stirring vigorously. After preparation of the stock solution, DI water was added to the sodium MMT dispersion; this dispersion was then ultrasonicated for 1 hour in an ultrasonication bath (Branson 8510R-MT, 250 watts (W), 44 kilohertz (kHz)). Next, the PVA solution was added to the sodium MMT dispersion followed by 1 hour of stirring. The final solids concentrations were 0.5 wt %, 1.0 wt %, or 1.5 wt %, where the mass of PVA and sodium MMT were equivalent (i.e., 0.25 wt % PVA and 0.25 wt % sodium MMT for a total 0.5 wt % solution and so forth). The dispersion was then ultrasonicated for an additional hour. Finally, a pre-determined amount of GA was added to the mixture as a cross-linking agent, such that the molar ratio of GA to hydroxy groups on PVA chains was 1:20. HCl was used as a catalyst for the cross-linking reaction in a 1:5 mole ratio to GA.

### Example 2—Method of PVA/MMT Nanocoating Via Rotational Coating

A piece of PET film was washed with DI water and then with ethanol prior to the coating process. The PET film was then adhered to the wall of the cylinder container using DI water. Extra DI water was removed by a syringe connected to a soft rubber tube. Then, the PET film was gently wiped with a non-particulating cloth (Kimwipes) to remove water droplets on the surface of the PET film. Next, 30 milliliters (mL) of a PVA/MMT dispersion (0.5 wt %, 1.0 wt %, or 1.5 wt %) made as described in Example 1 was charged into the cylinder container. The cylinder container was rotated at low speed (4.65 rpm; 0.014 m/s²) for four turns to wet the exposed surface of PET film. Excess dispersion was then removed by a syringe through a rubber tube. The remaining mass amounts of the dispersions were 3.27 grams (g), 3.42 g, and 3.51 g for 0.5 wt %, 1.0 wt %, and 1.5 wt % suspensions, respectively. Finally, the cylinder was set to the target rotational speed, and an infrared (IR) lamp was placed two centimeters (cm) above the cylinder to speed the evaporative drying process (FIG. 1). The cylinder was rotated for 20 minutes until the coating was completely dry. Rotation speeds and corresponding radial accelerations are provided in Table 2.

TABLE 2
Rotation Speeds of Example 2

| | Centripetal |
|---|---|
| RPM | acceleration (m/s²) |
| 4.65 | 0.0135 |
| 15.0 | 0.141 |
| 30.0 | 0.563 |
| 68.7 | 4.01 |
| 84.6 | 6.68 |
| 109 | 10.2 |
| 149 | 19.0 |
| 176 | 26.4 |
| 240 | 48.8 |
| 478 | 143 |
| 607 | 231 |
| 737 | 339 |
| 866 | 469 |
| 995 | 619 |
| 1124 | 790 |
| 1254 | 983 |
| 1383 | 1196 |
| 1512 | 1430 |
| 1641 | 1684 |
| 1771 | 1960 |

The measured thickness of the coating layer for the three PVA/MMT dispersions (0.5 wt %, 1.0 wt %, or 1.5 wt %) coated in Example 2 are shown in FIG. 3. A higher concentration of solids coated on the PET film resulted in increased coating thickness. A slight reduction in coating thickness was observed for higher acceleration. As shown in FIG. 3, increasing the dispersion concentration by two- or three-fold led to more than a two- or three-fold increase in the thickness of the nanocoating. These results are attributed to the coating method utilized in Example 2. In Example 2, differences in the amount of the dispersion remaining in the cylinder container for each concentration was affected by variations in viscosity, that is, higher PVA concentration dispersions had increased viscosity which led to an increased amount of dispersion adhered to the film before the drying process. As noted in Example 2, the remaining mass amounts of the dispersions removed from the container after pre-wetting were 3.27 grams (g), 3.42 g, and 3.51 g for 0.5 wt %, 1.0 wt %, and 1.5 wt % suspensions, respectively. The average thicknesses corresponding to these concentrations were 137.32 nanometers (nm) (0.5 wt %), 289.60 nm (1.0 wt %), and 444.93 nm (1.5 wt %). The respective coating layer thickness-to-solid mass ratios were 8,398 nanometers per gram (nm/g) (0.5 wt %), 8,476 nm/g (1.0 wt %), and 8,450 nm/g (1.5 wt %), with differences less than 1%, suggesting that the thickness discrepancy is primarily due to the viscosity-induced variation in the dispersion amount.

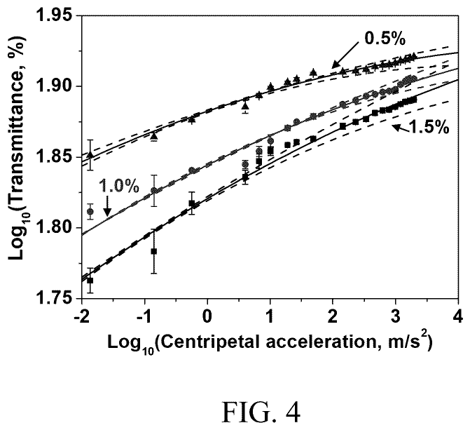

FIG. 4 displays the transmittance data for the PET coated films of Example 2. The overall transmittances at 400 nm for the 0.5 wt %, 1.0 wt %, and 1.5 wt % samples were over 80%, 70%, and 60%, respectively. Statistical model fitting results revealed that concentration (c), acceleration (a), the product of concentration and acceleration (ca), and squared acceleration (a²) had a statistically significant impact on the transmittance of coated PET films (p=0.035, <0.001, <0.001, <0.001, respectively). Lower thickness at lower concentration and higher acceleration contributes to higher transmittance.

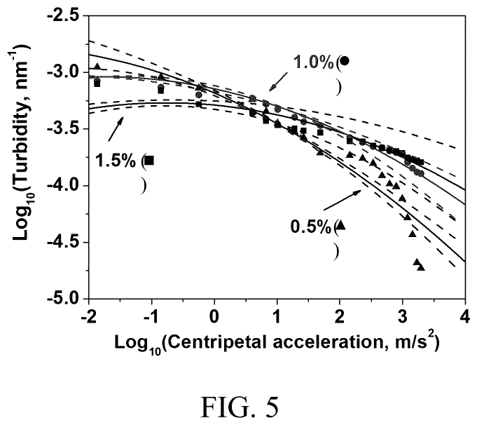

To determine whether the higher transmittance was due to lower thickness or a combination of lower thickness and other factors, the turbidities of the PVA/MMT nanocoatings of Example 2 were calculated. The turbidity calculations removed the contributing effects of coating thickness and substrate reflections on the optical properties of the coating. As shown in FIG. 5, a lower concentration and higher centripetal acceleration provided a lower turbidity and therefore a clearer coating. These results indicate higher transmittance of the coatings is due to a thinner coating and lower turbidity. A lower turbidity indicates increased orientation and alignment of the MMT nanosheets within the coating. The variation in the coating turbidity for the different dispersion concentrations indicates that the coating layers have lower turbidity at reduced concentrations. This variation can be attributed to the presence of fewer MMT nanosheets at lower concentrations, which facilitates alignment of the nanosheets under the same acceleration.

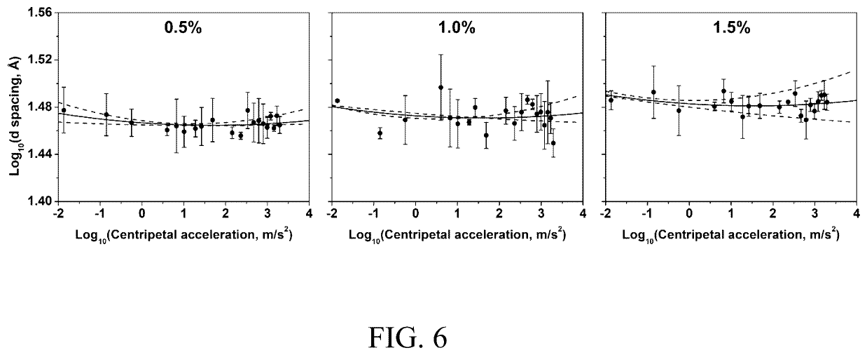

In FIG. 6, the interlayer distances (d spacing) between MMT nanosheets in the PVA/MMT nanocoatings of Example 2 were calculated from the XRD patterns. For these samples, PVA is the sole material present between MMT nanosheets and all samples have a fixed weight ratio of MMT to PVA of 1:1. In this example, higher centripetal acceleration did not contribute to a reduced d spacing.

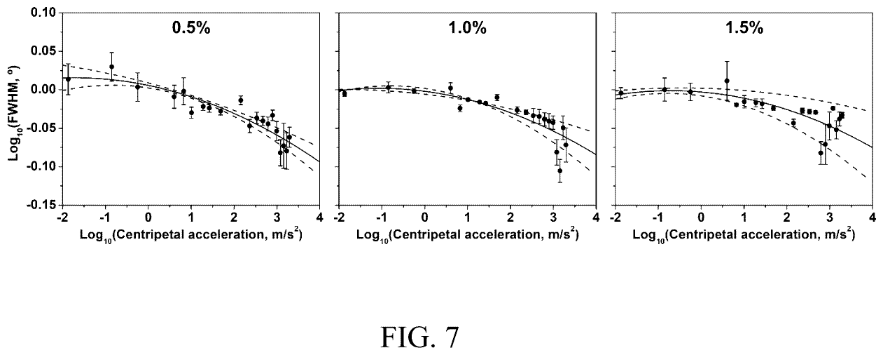

In FIG. 7, the Full Widths at Half Maximum (FWHM) in degrees for MMT nanosheets were calculated from the XRD patterns. For a material with perfect uniformity, all d spacing values would be identical, resulting in very narrow diffraction peaks and the FWHM would be minimal. These results indicate that higher acceleration leads to a more uniform distribution of d spacing, suggesting increased orientation and alignment of MMT nanosheets. Furthermore, at higher concentrations, the FWHM increases due to the dependency on “ca” [product of concentration and acceleration from equation (2)]. This is attributed to fewer MMT nanosheets present at lower concentrations, making it easier to achieve alignment under the same centripetal acceleration.

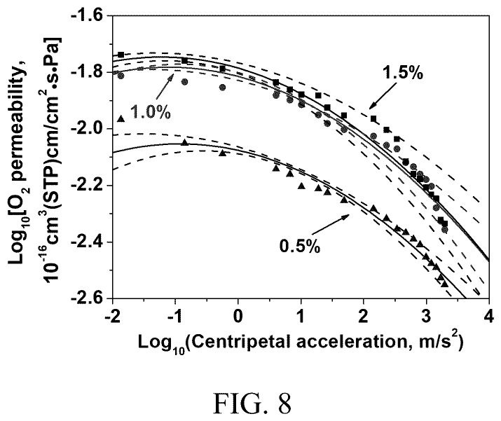

A high degree of nanosheet orientation and the compact packing of MMT nanosheets, lead to a tortuous path for gas permeation. As shown in FIG. 8, the nanocoatings, prepared as described in Example 2, demonstrated exceptional barrier properties. The barrier properties demonstrated low oxygen transmission rates (OTRs) of the coated films. To evaluate the performance of the nanocoating layer only, the oxygen permeability was calculated by subtracting the oxygen permeability of the PET substrate and correcting for coating thickness. The results of these corrected calculations are shown in FIG. 8. The oxygen permeability was found to be dependent on c (concentration), a (acceleration), c² (squared concentration), and a² (squared acceleration) (p=<0.001, 0.02, <0.001, <0.001, respectively, of Equation 2. The oxygen permeability decreased with higher acceleration. This can be attributed to the greater centripetal force exerted upon MMT nanosheets when the acceleration increases. Furthermore, as the dispersion mass concentration decreases, the oxygen permeability decreases. This decrease can be attributed to a smaller FWHM at lower concentration, where fewer nanosheets are present to align, resulting in enhanced orientation of the nanosheets and consequently lower oxygen permeability. The lowest permeability achieved with rotational coating was 0.0028×10⁻¹⁶ (cm³_{(STP)}cm)/(cm²·s·Pa) (for the 0.5 wt % suspension concentration, at a centripetal acceleration of 1960 m/s²). The observed oxygen permeability was significantly lower than the uncoated PET substrate [18.57×10⁻¹⁶ (cm³_{(STP)}cm)/(cm²·s·Pa)].

The rotational coating system described herein provides a setup to provide nanosheet coatings upon various substrates. A method of applying a nanosheet coating upon a substrate 103 can include the use of a rotational coating system 100 in the presence of a substrate 103 and a dispersion 110 of a binder 104, nanosheets 105, and a solvent 111. The substrate 103 and the dispersion 110 are rotated with removal of the solvent 111 to provide a coating on the exposed surface of the substrate 103. During coating, the rotating substrate 103 and dispersion 110 can be treated with heat, irradiated, and/or crosslinked to provide the final desired coating. The coatings provided from rotational coating exhibit low oxygen permeability.

While the disclosure has been described with reference to an exemplary embodiment, it will be understood by those skilled in the art that various changes may be made and equivalents may be substituted for elements thereof without departing from the scope of the disclosure. In addition, many modifications may be made to adapt a particular situation or material to the teachings of the disclosure without departing from essential scope thereof. Therefore, it is intended that the disclosure not be limited to the particular embodiment disclosed as the best mode contemplated for carrying out this disclosure, but that the disclosure will include all embodiments falling within the scope of the appended claims.

1. A coated article comprising:
a container that is optionally lined with a substrate and is characterized by an inner surface; and
a nanosheet coating comprising a binder and nanosheets; where the nanosheet coating is disposed on the inner surface; where the nanosheet coating displays a higher periodicity between the nanosheets in a direction parallel to the substrate than in a direction perpendicular to the substrate.

2. The coated article of claim 1, where an oxygen permeability of the nanosheet coating is less than about 0.03×10⁻¹⁶ standard cubic centimeter times nanosheet coating thickness in centimeters per centimeter squared seconds Pascals [10⁻¹⁶ (cm³_{STP}·cm)/(cm²·s·Pa)].

3. The coated article of claim 1, where the nanosheet coating is a crosslinked coating, where the nanosheets are interleaved; and wherein interleaving produces a plurality of tortuous pathways between the nanosheets.

4. The coated article of claim 1, where the container has one or more sealed ends.

5. The coated article of claim 1, where the container and the nanosheet coating disposed thereon are optically transparent.

6. The coated article of claim 1, where the substrate with the nanosheet coating disposed thereon are formed into a tray by molding, thermoforming or vacuum forming.

7. The coated article of claim 1, where the coated article is used to store ingestible solids or fluids.

8. A rotational coating system for disposing a nanosheet coating on a container comprises:
a motor, wherein the motor is operative to rotate the container that is optionally lined with a substrate and is characterized by an inner surface;
a source for discharging a dispersion on the inner surface; where the dispersion comprises a solvent, a binder and nanosheets; and
a radiation source; where the radiation source is operative to irradiate the dispersion to promote the formation of a nanosheet coating on the inner surface.

9. The system of claim 8, where the radiation source is operative to produce ultraviolet radiation, visible radiation, xray or electron beam radiation.

10. The system of claim 8, further comprising a heat source, a vacuum source, or a combination thereof, for drying the dispersion.

11. The system of claim 1, further comprising a pad disposed under the motor to absorb vibrational energy.

12. The system of claim 1, wherein the motor is operative to radially accelerate the container to a value of 0.01 to 20,000 meters per second squared.

13. A method for preparing a nanosheet coating on a container comprises:
charging a dispersion comprising a plurality of nanosheets, a binder and a solvent into the container; where the container is optionally lined with a substrate and is characterized by an inner surface;
rotating the container to cause spreading of the dispersion on the inner surface; and
removing the solvent during rotation to provide a nanosheet coating on the inner surface; where the nanosheet coating displays a higher periodicity between the nanosheets in a direction parallel to the substrate than in a direction perpendicular to the substrate.

14. The method of claim 13, wherein the container is rotated at a speed of 0.01 to 4500 revolutions per minute and/or a radial acceleration of 0.01 to 20,000 meters per second squared.

15. The method of claim 13, wherein the dispersion has a viscosity of about 0.3 millipascal second (mPa·s) to about 10,000 mPa·s.

16. The method of claim 13, wherein the dispersion of the plurality of nanosheets and the binder is in water, liquid carbon dioxide, liquid nitrogen, ethanol, dimethyl sulfoxide (DMSO), acetone, acetonitrile, methanol, butanol, propanol, tetrahydrofuran, N-methylpyrrolidone (NMP), N,N-dimethylpropyl amine, or a combination thereof.

17. The method of claim 13, wherein the binder and the nanosheets are present in the dispersion at a ratio of 20:1 to 1:20.

18. The method of claim 13, further comprising irradiating the dispersion to crosslink the binder.

19. The method of claim 13, wherein the binder and the nanosheets are each independently present in an amount of 0.05 to 20 weight percent based on a total weight of the dispersion.

20. The method of claim 18, further comprising molding the container or the substrate with the nanosheet coating disposed thereon.
